(19) United States
(12) Patent Application Publication
(10) Pub. No.: US 2021/0320923 A1
(43) Pub. Date: Oct. 14, 2021

(54) METHOD AND APPARATUS FOR REVOKING AUTHORIZATION OF API INVOKER

(71) Applicant: Telefonaktiebolaget LM Ericsson (publ), Stockholm (SE)

(72) Inventor: Wenliang XU, Shanghai (CN)

(73) Assignee: Telefonaktiebolaget LM Ericsson (publ), Stockholm (SE)

(21) Appl. No.: 17/261,881

(22) PCT Filed: Apr. 24, 2019
(86) PCT No.: PCT/CN2019/084090

§ 371 Date: Jan. 21, 2021

(30) Foreign Application Priority Data
Nov. 15, 2018 (CN) PCT/CN2018/115757

(51) Int. Cl. H04L 29/06

(52) U.S. Cl. CPC H04L 63/101; H04L 63/164; H04L 67/40

(57) ABSTRACT

A method for revoking authorization for an API invoker in a first apparatus. The method comprises sending to a second apparatus a request for revoking authorization of an Application Program Interface (API) for the API invoker with an API invoker ID, an API Exposing Function (AEF) identifier and at least one API identifier; and receiving a response to the request from the second apparatus wherein the API identified by the at least one API identifier is part of all the APIs authorized for the API invoker.

### FIELD OF THE INVENTION

The present disclosure generally relates to computer and communication technique fields, in particular to methods and apparatus for revoking authorization of an Application Programming Interface (API) invoker.

### BACKGROUND

In exemplary computer systems, an access token contains the security credentials for a login session and identifies the user, the user's groups, the user's privileges, and, in some cases, a particular application (refer to wiki https://en.wikipedia.org/wiki/Access_token).

Before Open Authorization (OAuth), a common pattern for granting access to your account to a third-party application was to simply give it your password and allow it to act as you.

This pattern of applications obtaining user passwords brings about some problems. Since the application would need to log in to the service as the user, these applications would often store users' passwords in plain text, making them a target for harvesting passwords. Once the application has the user's password, it has complete access to the user's account, including having access to capabilities such as changing the user's password. Another problem was that after giving an app your password, the only way you′d be able to revoke that access was by changing your password, something that users are typically reluctant to do.

Oauth 2.0 is called the version 2 of the OAuth protocol (also called framework). This protocol allows third-party applications to have limited access to a Hyper Text Transfer Protocol (HTTP) service, either on behalf of a resource owner or by allowing the third-party application to obtain access on its own behalf.

Oauth 2.0 has several authorization methods (e.g. Authorization Code Grant or Implicit Grant) as mentioned in RFC 6749.

For instance, using Authorization Code Grant, Mr. Lee has webchat/weibo account and wants to log on a third-party website. He can authorize the third-party website to use the webchat/weibo system authorized code (which is an access token) to fetch needed information (such as user's picture, contacts) from webchat/weibo.

The access token is requested by the client, and it is generated and granted by the authorization server. The authorization server may also generate a refresh token according to different authorization methods.

The access token may also be revoked by the client as specified in RFC 7009. The client needs to include the previously received access token in the request and the authorization server will revoke the access token if successful.

In Common API Framework (CAPIF), the CAPIF core function is the “authorization server” and API invoker is the “client”.

FIG. 1 is a schematic diagram illustrating an interaction procedure of requesting an access token in the prior art. The API invoker sends an access token request to the CAPIF core function, and the CAPIF core function sends an access token response to the API invoker in response to the request.

The access token is a JSON Web Token (JWT) as specified in IETF RFC 7519. The access token returned by the CAPIF core function includes the claims encoded as a JSON object as specified and then digitally signed using JWS as specified in IETF RFC 7515.

The claim includes a scope field which includes detailed information of the authorization, i.e. whether the API Exposure Function (AEF) can authorize different API access.

The scope contains a list of AEF identifiers and its associated API names for which the access token is authorized for use.

It takes the format of aefld1:apiName1,apiName2, . . . apiNameX; aefld2:apiName1,apiName2, . . . apiNameY; . . . aefldN:apiName1,apiName2, . . . apiNameZ.

Delimeter “:” is used after an AEF identifier, “,” between API names and “;” between the last API name of the previous AEF identifier and the next AEF identifier.

Here an example is provided as below:

‘aef-jiangsu-nanjing:3gpp-monitoring-event,3gpp-as-session-with-qos;aef-zhe jiang-hangzhou:3gpp-cp-parameter-provisioning,3gpp-pfd-management’.

FIG. 2 is a schematic diagram illustrating an interaction procedure of service API invocation with access token in the prior art.

As shown, after the API invoker obtains the Oauth 2.0 Access token generated by the CAPIF core function, the API invoker includes the access token in the Service API invocation request (step 6 in FIG. 2). And AEF will verify the access token and check authorization claims in token. If OK, it continues the API request and return response in step 8.

In 3GPP CAPIF, currently, there is no mechanism to support the partial revocation for a token. The RFC 7009 cannot revoke part of the authorized information but only the whole access token. For example, for certain APIs, e.g. ‘3gpp-monitoring-event’, the AEF may, at certain point of time, detect the number of invocations exceeds certain limit by the access control policy in the AEF, then the AEF decides to revoke the authorization for such APIs, but keep the rest APIs accessible.

### SUMMARY

In view of the above, it is an object to provide an extension of the CAPIF to support both the server initiated and client initiated partial revocation for an access token.

According to one aspect of the disclosure, there is provided a method for revoking authorization for an API invoker in a first apparatus, comprising: sending a request for revoking authorization of an Application Program Interface (API) for the API invoker to a second apparatus with an API invoker ID, an API Exposing Function (AEF) identifier and at least one API identifier; and receiving a response to the request from the second apparatus.

In one embodiment, the first apparatus is an AEF and the second apparatus is an authorization server.

In another embodiment, the first apparatus is an authorization server and the second apparatus is an AEF.

The request can be sent, via an HTTP POST message containing the API invoker ID, the AEF identifier and the at least one API identifier, to an URI on the second apparatus.

The HTTP POST message may further contain a cause for revoking the authorization of the API identified by the at least one API identifier for the API invoker.

The AEF may be a Service Capability Exposure Function (SCEF); a Network Exposure Function (NEF); or a Broadcast Multicast Service Center (BMSC); and the authorization server may be a CAPIF Core function.

The method may further include invalidating the authorization of the API indicated by the at least one API identifier with the AEF for the API invoker.

The method may further include notifying the API invoker of revocation of the authorization of API identified by the at least one API identifier with the AEF.

The response to the request from the second apparatus may include an acknowledge message for the request.

The API identified by the at least one API identifier is part of all the APIs authorized for the API invoker.

According to another aspect of the disclosure, there is provided a method for revoking authorization for an API invoker in a second apparatus, comprising: receiving a request for revoking authorization of an Application Program Interface (API) for the API invoker from a first apparatus with an API invoker ID, an API Exposing Function (AEF) identifier and at least one API identifier; and sending a response to the request to the first apparatus.

In one embodiment, the first apparatus is an AEF and the second apparatus is an authorization server.

In another embodiment, the first apparatus is an authorization server and the second apparatus is an AEF.

The request can be received, via an HTTP POST message containing the API invoker ID, the AEF identifier and the at least one API identifier.

The HTTP POST message may further contain a cause for revoking the authorization of the API identified by the at least one API identifier for the API invoker.

The AEF may be a Service Capability Exposure Function (SCEF); a Network Exposure Function (NEF); or a Broadcast Multicast Service Center (BMSC); and the authorization server may be a CAPIF Core function.

The method may further include invalidating the authorization of the API indicated by the at least one API identifier with the AEF for the API invoker.

The method may further include notifying the API invoker of revocation of the authorization of API identified by the at least one API identifier with the AEF.

The response to the request to the first apparatus comprises an acknowledge message for the request.

The API identified by the at least one API identifier is part of all the APIs authorized for the API invoker.

According to a third aspect of the disclosure, there is provided a first apparatus for revoking authorization of an Application Program Interface (API) invoker, comprising: a sending module, configured to send a request for revoking authorization of an Application Program Interface (API) for the API invoker to a second apparatus with an API invoker ID, an API Exposing Function (AEF) identifier and at least one API identifier; and a receiving module, configured to receive a response to the request from the second apparatus.

According to a fourth aspect of the disclosure, there is provided a first apparatus for revoking authorization of an Application Program Interface (API) invoker, comprising: one or more processors; and one or more memories comprising computer program configured to, when executed by the one or more processors, cause the first apparatus to execute any of the methods according to the embodiments.

According to a fifth aspect of the disclosure, there is provided a second apparatus for revoking authorization of an Application Program Interface (API) invoker, comprising: a receiving module, configured to receive a request for revoking authorization of an Application Program Interface (API) for the API invoker from a first apparatus with an API invoker ID, an API Exposing Function (AEF) identifier and at least one API identifier; and a sending module, configured to send a response to the request to the first apparatus.

According to a sixth aspect of the disclosure, there is provided a second apparatus for revoking authorization of an Application Program Interface (API) invoker, comprising: one or more processors; and one or more memories comprising computer program configured to, when executed by the one or more processors, cause the first apparatus to execute any of the methods according to the embodiments.

According to a seventh aspect of the disclosure, there is provided a computer-readable medium having computer program stored thereon, wherein the computer program comprises codes for performing the method according to the embodiments.

According to the embodiments of the present disclosure, access token revocation with a finer granularity is achieved. This allows a better control of the access token.

### BRIEF DESCRIPTION OF THE DRAWINGS

The above and other objects, features and advantages will be more apparent from the following description of embodiments with reference to the accompanied drawings, in which:

FIG. 1 is a schematic diagram illustrating an interaction procedure of requesting an access token in the prior art;

FIG. 2 is a schematic diagram illustrating an interaction procedure of service API invocation with access token in the prior art;

FIG. 3 is a schematic diagram illustrating an interaction procedure for revoking authorization of API invoker initiated by AEF according to an embodiment of the present application;

FIG. 4 is a schematic diagram illustrating an interaction procedure for revoking authorization of API invoker initiated by a CAPIF core Function according to an embodiment of the present application;

FIG. 5 is a schematic diagram illustrating a method for revoking authorization of an API invoker in a first apparatus according to an embodiment of the present application;

FIG. 6 is a schematic diagram illustrating a method for revoking authorization of an API invoker in a second apparatus according to an embodiment of the present application;

FIG. 7 is a schematic block diagram of a first apparatus for revoking authorization of an API invoker according to an embodiment of the present application;

FIG. 8 is a schematic block diagram of a second apparatus for revoking authorization of an API invoker according to an embodiment of the present application;

FIG. 9A is a schematic block diagram of a first apparatus for revoking authorization of an API invoker according to an embodiment of the present application;

FIG. 9B is a schematic block diagram of a second apparatus for revoking authorization of an API invoker according to an embodiment of the present application;

FIG. 10 shows a schematic diagram of a procedure for authentication between the API invoker and the AEF prior to service API invocation according to an embodiment of the present application;

FIG. 11 shows a schematic diagram of Security method negotiation procedure according to an embodiment of the present application; and

FIG. 12 shows a schematic diagram of resource URI structure of the CAPIF Security API according to an embodiment of the present application.

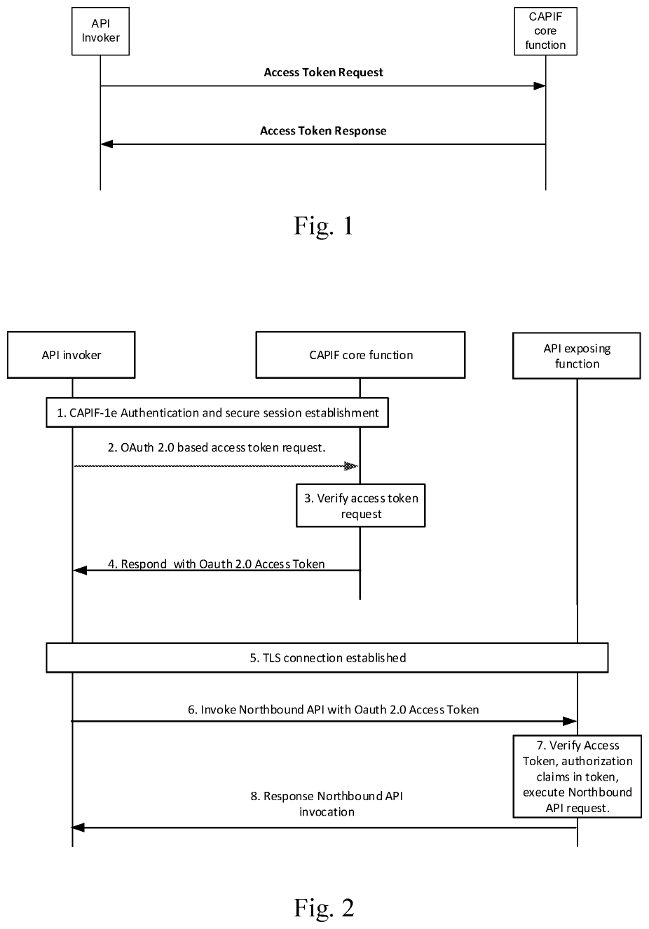

### DETAILED DESCRIPTION

Following embodiments of the present disclosure are described in detail with reference to the accompanying drawings. It shall be understood that these embodiments are discussed only for the purpose of enabling those skilled persons in the art to better understand and thus implement the present disclosure, rather than suggesting any limitations on the scope of the present disclosure.

In the context, Common API Framework (CAPIF) refers to a framework comprising common API aspects that are required to support service APIs. Service API (or called as API) refers to the interface through which a component of the system or platform exposes its services to API invokers by abstracting the services from the underlying mechanisms. API invoker may access the related service by the service API. API invoker refers to the entity which invokes the CAPIF or service APIs. API exposing function (AEF) refers to the entity which provides the service communication entry point for the service APIs. Northbound API refers to a service API exposed to higher-layer API invokers. Resource refers to the object or component of the API on which the operations are acted upon.

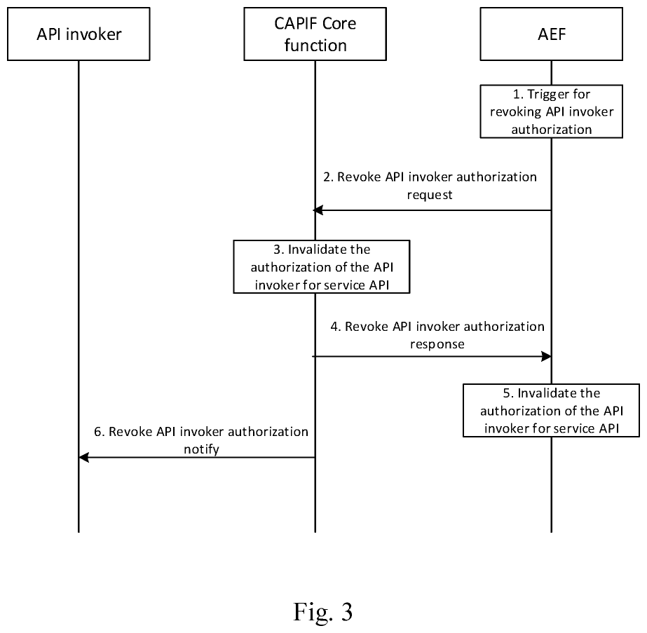

FIG. 3 is a schematic diagram illustrating an interaction procedure for revoking authorization of API invoker initiated by AEF according to an embodiment of the present application.

The invalidation of authorization may be performed using Revoke_Authorization service operation as follows.

Specifically, to invalidate authorization of all service APIs for an API invoker, the API exposing function (AEF) may send an HTTP DELETE message to the CAPIF core function using the API invoker ID.

Upon receiving the above described HTTP DELETE message, the CAPIF core function will delete the resource representation pointed by the API invoker ID and notify the API invoker of the authorization invalidation using the Notification Destination URI received in the Obtain_Security_Method message.

In an embodiment of the present disclosure, when some access control rule related to access to one or more service APIs associated with an AEF for an API invoker is unsatisfied, AEF or CAPIF Core function may be triggered to revoke the authorization to the one or more service APIs.

The access control rule related to access to one or more service APIs may be configured by CAPIF or AEF. For example, the access control rule may include, such as, the number of invocations for some service API(s) exceeds a specified limit; or some service APIs are not allowed to be invoked during some specified time period, etc.

To invalidate authorization of some service APIs for an API invoker, the API exposing function will send an HTTP POST message to the CAPIF core function with the API invoker ID, a list of API identifiers and the identifier of the AEF, to the URI on the CAPIF core function, e.g., “{apiRoot}/capif-security/v1/securities/{securityId}/delete”.

Upon receiving the HTTP POST message, the CAPIF core function will revoke the authorization of some service APIs (associated with the AEF) identified by the list of API identifiers for the API invoker indicated by the API invoker ID and notify the API invoker of the authorization invalidation using the Notification Destination URI received in the e.g. Obtain_Security_Method message.

In particular, the CAPIF core function may modify or update the scope field in the claim stored in the local memory of the CAPIF core function itself while the existing access token needs not be changed or updated. The scope field contains a list of AEF identifiers and the name list of its associated accessible APIs. In particular, for example, the CAPIF core function may remove the API identifiers (revoked by the AEF) from the API name list associated with the AEF contained in the scope field based on the authorization revocation request.

As a response, the CAPIF core function may acknowledge the HTTP request from the API exposing function.

This custom authorization revocation operation revokes authorization for service APIs of an existing Individual security instance resource in the CAPIF core function.

This operation may support the request data structures specified in table 1 and the response data structure and response codes specified in table 2.

TABLE 1
Data structures supported by the POST
Request Body on this resource

| | | Cardi- | |
|---|---|---|---|
| Data type | P | nality | Description |
| SecurityNotification | M | 1 | It includes a list of APIs |
| | | | to be revoked for an |
| | | | API invoker. |

TABLE 2
Data structures supported by the POST
Response Body on this resource

| Data | | Cardi- | Response | |
|---|---|---|---|---|
| type | P | nality | codes | Description |
| n/a | | | 204 No | Successful case. |
| | | | Content | The CAPIF core function |
| | | | | revoked the authorization |
| | | | | for the requested APIs to |
| | | | | the API invoker. |

NOTE
1: In addition, the HTTP status codes which are specified as mandatory in
3GPP TS 29.500 [5] for the POST method shall also apply.

As an example, data type SecurityNotification is defined as table 3.

TABLE 3
Definition of data type SecurityNotification

| | | | | | Ap- |
|---|---|---|---|---|---|
| Attribute | Data | | Cardi- | | plica- |
| name | type | P | nality | Description | bility |
| apiInvokerId | string | M | 1 | String identifying the API | |
| | | | | invoker assigned by the | |
| | | | | CAPIF core function | |
| aefId | string | M | 1 | String identifying the AEF. | |
| apiIds | Array | M | 1 . . . N | Identifier of the service | |
| | (string) | | | API | |
| cause | Cause | M | 1 | The cause for revoking the | |
| | | | | API invoker authorization | |
| | | | | to the service API | |

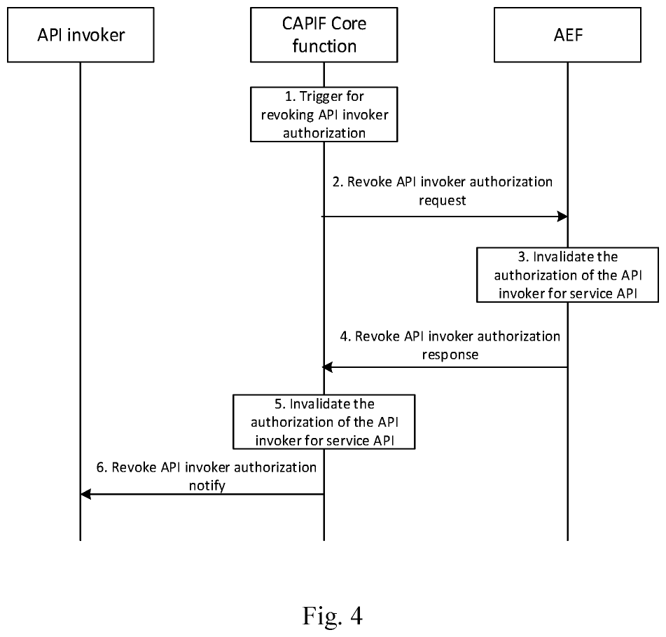

FIG. 4 is a schematic diagram illustrating an interaction procedure for revoking authorization of API invoker initiated by a CAPIF core Function according to an embodiment of the present application.

As shown, partial revocation of some service APIs associated with an AEF for an API invoker may be triggered from the CAPIF core function.

This service operation (i.e., Revoke_Authorization service operation) is used by CAPIF core function to revoke authorization of service APIs. On receiving the Authorization revocation request, the API exposing function revokes authorization of service APIs for the API invoker.

In an embodiment, when CAPIF Core function is triggered to revoke authorization of some specified service APIs associated with AEF for an API invoker, CAPIF core function initiates the authorization revocation using e.g. Revoke_Authorization service operation.

To initiate authorization revocation, the CAPIF core function will send an HTTP POST message to the API exposing function (AEF) with the API invoker ID, a list of service API IDs, and an identifier of the AEF to the URI “{apiRoot}/aef-security/v1/revoke-authorization”.

Upon receiving the above described HTTP POST message, the API exposing function will revoke the authorization for the service APIs identified by the list of service API IDs associated with the API invoker indicated by the API invoker ID, and then respond the CAPIF core function with 200 OK status code if the authorization revocation is successful.

This custom authorization revocation operation allows the CAPIF core function to request the API exposing function to revoke the authorization of service APIs for an API invoker.

In particular, the AEF may modify or update the scope field in the claim stored in the local memory of the AEF itself. The scope field contains a list of AEF identifiers and the name list of its associated accessible APIs while the existing access token needs not be changed or updated. In particular, for example, the AEF may remove the API identifiers (revoked by the CAPIF core function) from the API name list associated with the AEF contained in the scope field based on the authorization revocation request.

This authorization revocation operation shall support the request and response data structures, and response codes specified in tables 4 and 5.

TABLE 4
Data structures supported by the POST
Request Body on this operation

| | | Cardi- | |
|---|---|---|---|
| Data type | P | nality | Description |
| RevokeAuthorizationReq | M | 1 | Authorization revocation |
| | | | request data |

TABLE 5
Data structures supported by the POST
Response Body on this operation

| | | Cardi- | Response | |
|---|---|---|---|---|
| Data type | P | nality | codes | Description |
| RevokeAuthorizationRsp | M | 1 | 200 OK | The request was |
| | | | | successful. |

NOTE:
In addition, the HTTP status codes which are specified as mandatory in
3GPP TS 29.500 [xx] for the POST method shall also apply.

As an example, date type RevokeAuthorizationReq is defined in Table 6.

TABLE 6
Definition of type RevokeAuthorizationReq

| | | | | | Ap- |
|---|---|---|---|---|---|
| Attribute | Date | | Cardi- | | plica- |
| name | type | P | nality | Description | bility |
| revokeInfo | Security | M | 1 | It contains detailed | |
| | Notification | | | revocation | |
| | | | | information. | |
| supported | Supported | M | 1 | Used to negotiate the | |
| Features | Features | | | supported optional | |
| | | | | features of the API. | |
| | | | | This attribute shall | |
| | | | | be provided in the | |
| | | | | HTTP POST | |
| | | | | request and | |
| | | | | response. | |

As an example, data type RevokeAuthorizationRsp is defined in Table 7.

TABLE 7
Definition of type RevokeAuthorizationRsp

| | | | | | Ap- |
|---|---|---|---|---|---|
| Attribute | Data | | Cardi- | | plica- |
| name | type | P | nality | Description | bility |
| supported | Supported | M | 1 | Used to negotiate the | |
| Features | Features | | | supported optional | |
| | | | | features of the API. | |
| | | | | This atttribute shall be | |
| | | | | provided in the HTTP | |
| | | | | POST request and | |
| | | | | response. | |

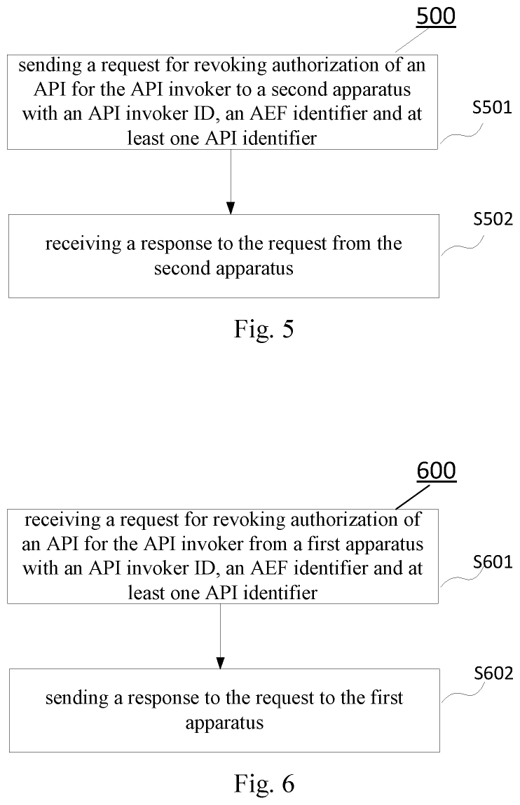

FIG. 5 is a schematic diagram illustrating a method 500 for revoking authorization of an API invoker in a first apparatus according to an embodiment of the present application.

The method 500 includes step S501 and step S502. In step S501, a request is sent to a second apparatus for revoking authorization of an API for the API invoker, and the request contains an API invoker ID, an API Exposing Function (AEF) identifier and at least one API identifier. In step S502, a response to the request is received from the second apparatus.

The API invoker ID is used to identify an API invoker which intends to access some specified service API(s). The AEF identifier is used to identify the AEF associated with the service API(s) to be revoked. The API identifier is used to identify the API(s) to be revoked by the API invoker.

In a first embodiment of the method, the first apparatus may be an AEF and the second apparatus may be an authorization server. In this situation, the method 500 may include the AEF sends a request to the authorization server for revoking authorization of an API for the API invoker, and receives a response from the authorization server.

In the first embodiment of the method, the request may be sent, via an HTTP POST message containing the API invoker ID, the AEF identifier and the at least one API identifier, to an URI on the authorization server, e.g., {apiRoot}/capif-security/v1/securities/{securityId}/delete”.

The HTTP POST message may further contain a cause for revoking the authorization of the API identified by the at least one API identifier for the API invoker.

The AEF could be implemented as a Service Capability Exposure Function (SCEF), a Network Exposure Function (NEF) or a Broadcast Multicast Service Center (BMSC).

The authorization server could be implemented as a Common API Framework (CAPIF) Core function.

In the first embodiment, in response to the request from the AEF, the authorization server may invalidate the authorization of the API indicated by the at least one API identifier with the AEF for the API invoker by modifying the scope field maintained on itself. After the invalidation of the authorization, the authorization server may send a response indicating the result of the invalidation operation to the AEF. If the result of the invalidation operation is positive (i.e., authorization revocation is successful), AEF will invalidate the authorization of the service API(s) for the API invoker by modifying the scope field maintained on itself.

Further, the authorization server may notify the API invoker of revocation of the authorization of API identified by the at least one API identifier with the AEF e.g. when the invalidation of authorization operation is successful on both the authorization server and the AEF.

Further, the authorization server may send an acknowledge message to the AEF in response to the request.

The API identified by the at least one API identifier is a part of all the APIs authorized for the API invoker.

In a second embodiment of the method 500, the first apparatus may be an authorization server and the second apparatus may be an AEF. In this situation, the method 500 may include the authorization server sends a request to the AEF for revoking authorization of an API for the API invoker, and receives a response from the AEF.

In the second embodiment, the request may be sent, via an HTTP POST message containing the API invoker ID, the AEF identifier and the at least one API identifier, to an URI on the AEF, e.g., {apiRoot}/capif-security/v1/securities/{securityId}/delete”.

In the second embodiment, in response to the request from the authorization server, the AEF may invalidate the authorization of the API indicated by the at least one API identifier with the AEF for the API invoker by modifying the scope field maintained on itself. After the invalidation of the authorization, the AEF may send a response indicating the result of the invalidation operation to the authorization server. If the result of the invalidation operation is positive (i.e., authorization revocation is successful), the authorization server will invalidate the authorization of the service API(s) for the API invoker by modifying the scope field maintained on itself.

Further, the authorization server may notify the API invoker of revocation of the authorization of API identified by the at least one API identifier with the AEF e.g. when the invalidation of authorization operation is successful on both the authorization server and the AEF.

Further, the AEF may send an acknowledge message to the authorization server in response to the request.

Other features adapted to the first embodiment may also apply to the second embodiment and thus are omitted herein.

FIG. 6 is a schematic diagram illustrating a method 600 for revoking authorization of an API invoker in a second apparatus according to an embodiment of the present application.

The method 600 includes step S601 and step S602. In step S601, a request is received for revoking authorization of an API for the API invoker from a first apparatus, and the request contains an API invoker ID, an API Exposing Function (AEF) identifier and at least one API identifier. In step S602, a response is sent to the first apparatus in response to the request.

In a first embodiment of the method 600, the first apparatus may be an AEF and the second apparatus may be an authorization server. In this situation, the method 600 may include the authorization server receives a request from the AEF for revoking authorization of an API for the API invoker, and sends a response to the AEF in response to the request.

In the first embodiment, the request is received, via an HTTP POST message containing the API invoker ID, the AEF identifier and the at least one API identifier.

The HTTP POST message further contains a cause for revoking the authorization of the API identified by the at least one API identifier for the API invoker.

The AEF may be implemented as a SCEF, a NEF or a BMSC; and the authorization server may be implemented as a CAPIF Core function.

In the first embodiment of the method 600, in response to the request from the AEF, the authorization server may invalidate the authorization of the API indicated by the at least one API identifier with the AEF for the API invoker by modifying the scope field maintained on itself. After the invalidation of the authorization, the authorization server may send a response indicating the result of the invalidation operation to the AEF. If the result of the invalidation operation is positive (i.e., authorization revocation is successful), the AEF will invalidate the authorization of the service API(s) for the API invoker by modifying the scope field maintained on itself.

Further, the authorization server may notify the API invoker of revocation of the authorization of API identified by the at least one API identifier with the AEF e.g. when the invalidation of authorization operation is successful on both the authorization server and the AEF.

Further, the authorization server may send an acknowledge message to the AEF in response to the request.

The API identified by the at least one API identifier is part of all the APIs authorized for the API invoker.

In a second embodiment of the method 600, the first apparatus may be an authorization server and the second apparatus may be an AEF. In this situation, the method 600 may include the AEF receives a request from the authorization server for revoking authorization of an API for the API invoker, and sends a response to the authorization server in response to the request.

In the second embodiment, the request is received, via an HTTP POST message containing the API invoker ID, the AEF identifier and the at least one API identifier.

In the second embodiment of the method 600, in response to the request from the authorization server, the AEF may invalidate the authorization of the API indicated by the at least one API identifier with the AEF for the API invoker by modifying the scope field maintained on itself. After the invalidation of the authorization, the AEF may send a response indicating the result of the invalidation operation to the authorization server. If the result of the invalidation operation is positive (i.e., authorization revocation is successful), the authorization server will invalidate the authorization of the service API(s) for the API invoker by modifying the scope field maintained on itself.

Further, the authorization server may notify the API invoker of revocation of the authorization of API identified by the at least one API identifier with the AEF e.g. when the invalidation of authorization operation is successful on both the authorization server and the AEF.

Other features adapted to the first embodiment of method 600 may also apply to the second embodiment of the method 600 and thus are omitted herein.

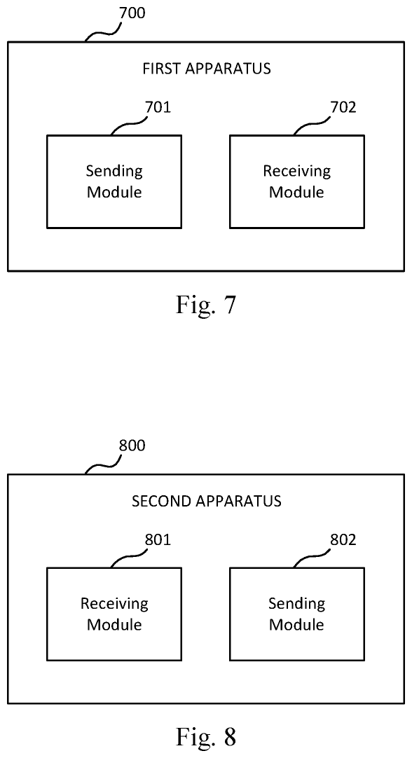

FIG. 7 is a schematic block diagram of a first apparatus 700 for revoking authorization of an API invoker according to an embodiment of the present application.

In an embodiment, the first apparatus 700 may include a sending module 701 and a receiving module 702. The sending module 701 sends a request for revoking authorization of an API for the API invoker to a second apparatus, and the request contains an API invoker ID, an API Exposing Function (AEF) identifier and at least one API identifier. The receiving module 702 receives a response from the second apparatus in response to the request.

FIG. 8 is a schematic block diagram of a second apparatus 800 for revoking authorization of an API invoker according to an embodiment of the present application.

In an embodiment, the second apparatus 800 includes a receiving module 801 and a sending module 802. The receiving module 801 receives a request for revoking authorization of an API for the API invoker from a first apparatus with an API invoker ID, an AEF identifier and at least one API identifier. The sending module 802 sends a response to the first apparatus in response to the request.

The first apparatus may be an AEF and the second apparatus may be an authorization server. Alternatively, the first apparatus may be an authorization server and the second apparatus may be an AEF.

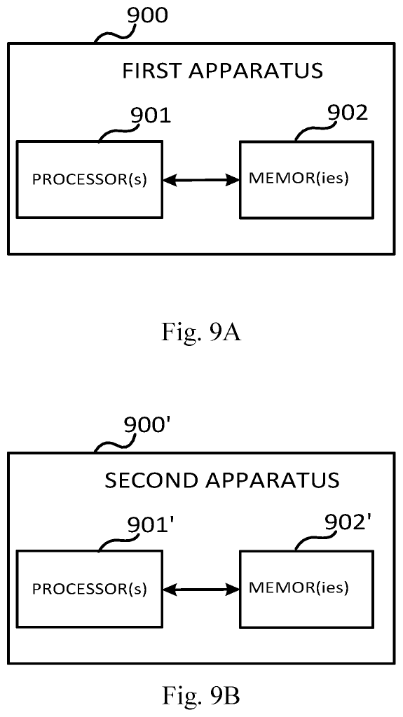

FIG. 9A is a schematic block diagram of a first apparatus 900 for revoking authorization of an API invoker according to an embodiment of the present application.

In another embodiment, the first apparatus 900 may include one or more processors; and one or more memories comprising computer program configured to, when executed by the one or more processors, cause the first apparatus to execute the corresponding methods of the above embodiments.

FIG. 9B is a schematic block diagram of a second apparatus 900′ for revoking authorization of an API invoker according to an embodiment of the present application.

In another embodiment, the second apparatus 900′ may include one or more processors; and one or more memories comprising computer program configured to, when executed by the one or more processors, cause the second apparatus to execute the corresponding methods of the above embodiments.

The features in the methods for revoking authorization of an API invoker described above may be applied in the corresponding first and second apparatuses as suitable and will not repeat here.

The embodiments described above may provide finer granular revocation on API level.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

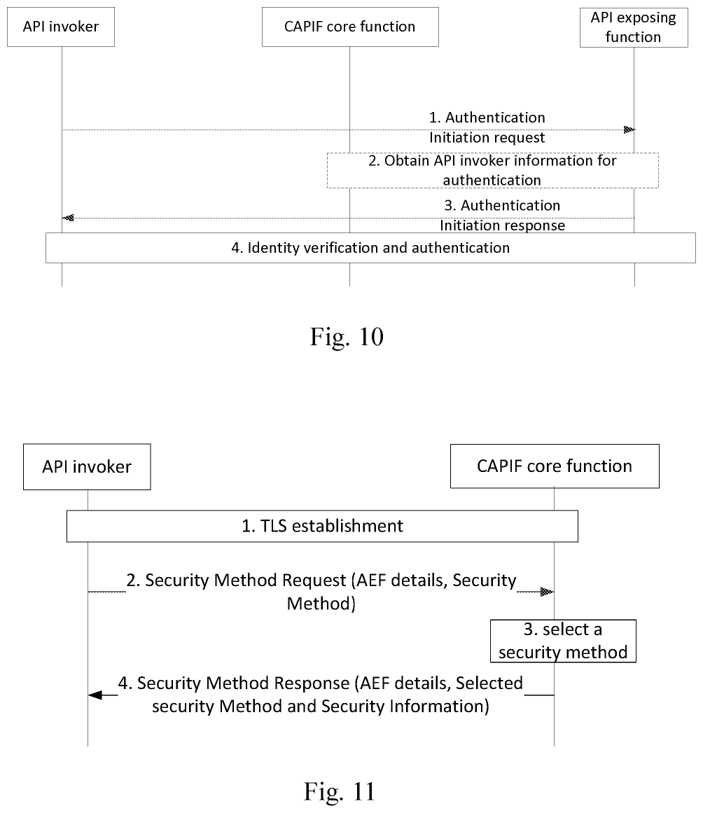

The embodiments of the disclosure further include:
1. Currently, the AEF_Authentication_API uses standard HTTP GET method for the API invoker to confirm that the AEF has enough authentication information available, which will be used in later API invocation.
TS 23.222 says:
FIG. 10 shows a procedure for authentication between the API invoker and the AEF prior to service API invocation.
In step 2 above, AEF requests the information from CAPIF core function if not available locally. The GET method targets to an existing resource in the AEF called “/auth-profiles”, and AEF returns “204 no content” as positive response. 204 means “/auth-profiles” is an empty resource (of document or collection type); and other actions, for instance, the storage of authentication information, are just collateral handling of such GET method.
Since the resource URI is just an entry point to trigger the collateral actions, it should be modelled as custom operation without association to a resource.
2. Besides, there is another service operation required by the AEF_Security_API in TS 23.222:

TABLE 11.1-1
List of API exposing function APIs

| | | Known | Communication |
|---|---|---|---|
| API Name | API Operations | Consumer(s) | Type |
| AEF_Security | Revoke_ | CAPIF Core | Request/ |
| API | Authorization | Function | Response |
| | Initiate_ | API Invoker | Request/ |
| | Authentication | | Response |

Currently, in TS 29.222, such operation is modelled as event notification as part of CAPIF core services and with event name API INVOKER AUTHORIZATION REVOKED.
But the CAPIF Security API already contains the notification of “revoke authorization” so API invoker doesn't use the dedicated event. Therefore it is proposed to have dedicated service operation provided by the AEF instead of using CAPIF event.

### Proposed Changes:

### 6.1 Introduction of Services

The table 6.1-1 lists the API exposing function APIs below the service name. A service description subclause for each API gives a general description of the related API.

TABLE 6.1-1
List of AEF Services

| | Service | Operation | |
|---|---|---|---|
| Service Name | Operations | Semantics | Consumer(s) |
| AEF_Security_ | Initiate_ | Request/ | API Invoker |
| API | Authentication | Response | |
| | Revoke_ | Request/ | CAPIF core |
| | Authorization | Response | function |

### *** Next Change ***

### 6.2 AEF_Security_API

### *** Next Change ***

### 6.2.1.1 Overview

The AEF security API, allows an API invoker via CAPIF-2/2e reference points to request API exposing function to ensure that authentication parameters necessary for authentication of the API invoker are available with the API exposing function. If the necessary authentication parameters are not available, the API exposing function fetches necessary authentication parameters from CAPIF core function to authenticate the API invoker.

The AEF security API, also allows the CAPIF core function via CAPIF-3 reference point to request API exposing function to revoke the authorization of service APIs for an API invoker.

### *** Next Change ***

### 6.2.2.1 Introduction

The service operation defined for AEF_Security_API is shown in table 6.2.2.1-1.

TABLE 6.2.2.1-1
Operations of the AEF_Security_API

| Service | | |
|---|---|---|
| operation | | |
| name | Description | Initiated by |
| Initiate_ | This service operation is used by an | API invoker |
| Authentication | API invoker to request API exposing | |
| | function to confirm necessary | |
| | authentication data is available to | |
| | authenticate the API invoker | |
| Revoke_ | This service operation is used by the | CAPIF core |
| Authorization | CAPIF core function to request the | function |
| | API exposing function to revoke the | |
| | authorization of service APIs for an | |
| | API invoker. | |

### *** Next Change ***

### 6.2.2.2 Initiate Authentication

### *** Next Change ***

### 6.2.2.2.1 General

This service operation is used by an API invoker to initiate authentication with the API exposing function. On receiving the Initiate Authentication the API exposing function fetches the authentication information of the API invoker from the CAPIF core function, if required.

### *** Next Change ***

### 6.2.2.2.2 API Invoker Initiating Authentication Using Initiate Authentication Service Operation

To initiate authentication with the API exposing function, the API invoker shall send an HTTP POST message to the API exposing function with the API invoker ID to the URI “{apiRoot}/aef-security/v1/check-authentication”.
Upon receiving the above described HTTP POST message, the API exposing function shall check if the credentials of the API invoker for authentication are available with the API exposing function. If the credentials of the API invoker for authentication are not available, the API exposing function shall use the service defined in subclause 5.6.2.4.2 to fetch the credentials from the CAPIF core function. The API exposing function shall store the received credentials and respond the API invoker with 200 OK status code.

### *** Next Change ***

### 6.2.2.x Revoke_Authorization

### 6.2.2.x.1 General

This service operation is used by CAPIF core function to revoke authorization of service APIs. On receiving the Revoke_Authorization the API exposing function revokes authorization of service APIs for the API invoker.

### 6.2.2.x.2 CAPIF Core Function Initiating Revocation Using Revoke_Authorization Service Operation

To initiate authorization revocation, the CAPIF core function shall send an HTTP POST message to the API exposing function with the API invoker ID and a list of service API IDs to the URI “{apiRoot}/aef-security/v1/revoke-authorization”.
Upon receiving the above described HTTP POST message, the API exposing function shall revoke the authorization for the indicated API invoker and its associated service APIs, and then respond the CAPIF core function with 200 OK status code.
The CAPIF core function shall also notify the API invoker of the authorization invalidation using the Notification Destination URI received in the Obtain_Security_Method message.

### *** Next Change ***

### 7.5 URI Structure

### 7.5.x Resource URI Structure

All resource URIs of CAPIF APIs should have the following root structure:
{apiRoot}/{apiName}/{apiVersion}/
“apiRoot” is configured by means outside the scope of the present document. It includes the scheme (“https”), host and optional port, and an optional prefix string. “apiName” and “apiVersion” shall be set dependent on the API, as defined in the corresponding subclauses below.
All resource URIs in the subclauses below are defined relative to the above root URI.
NOTE 1: The “apiVersion” will only be increased if the new API version contains backward incompatible changes. Otherwise, the supported feature mechanism defined in subclause 7.8 can be used to negotiate extensions.
NOTE 2: A different root structure can be used when the resource URI is preconfigured in the API invoking entity.
The root structure may be followed by “apiSpecificSuffixes” that are dependent on the API and are defined separately for each API where they apply:
{apiRoot}/{apiName}/{apiVersion}/{apiSpecific Suffixes}

### 7.5.y Custom Operations URI Structure

The custom operation definition is in Annex C of 3GPP TS 29.501 [18].
The URI of a custom operation which is associated with a resource shall have the following structure:
{apiRoot}/{apiName}/{apiVersion}/{apiSpecificResourceUriPart}/{custOpName}
Custom operations can also be associated with the service instead of a resource. The URI of a custom operation which is not associated with a resource shall have the following structure:
{apiRoot}/{apiName}/{apiVersion}/{custOpName}
In the above URI structures, “apiRoot”, “apiName”, “apiVersion” and “apiSpecificResourceUriPart” are as defined in subclause 7.5.1 and “custOpName” represents the name of the custom operation as defined in subclause 5.1.3.2 of 3GPP TS 29.501 [18].

### *** Next Change ***

### 8.3.4.3.3 Enumeration: CAPIFEvent

TABLE 8.3.4.3.3-1
Enumeration CAPIFEvent

| Enumeration value | Description | Applicability |
|---|---|---|
| SERVICE_API_AVAILABLE | Events related to the availability of | |
| | service APIs after the service APIs | |
| | are published. | |
| SERVICE_API_UNAVAILABLE | Events related to the unavailability of | |
| | service APIs after the service APIs | |
| | are unpublished. | |
| SERVICE_API_UPDATE | Events related to change in service | |
| | API information | |
| API_INVOKER_ONBOARDED | Events related to API invoker | |
| | onboarded to CAPIF | |
| API_INVOKER_OFFBOARDED | Events related to API invoker | |
| | offboarded from CAPIF | |
| SERVICE_API_INVOCATION_SUCCESS | Events related to the successful | |
| | invocation of service APIs | |
| SERVICE_API_INVOCATION_FAILURE | Events related to the failed invocation | |
| | of service APIs | |
| ACCESS_CONTROL_POLICY_UP | Events related to the update for the | |
| DATE | access control policy related to the | |
| | service APIs | |
| ACCESS_CONTROL_POLICY_UNAVAILABLE | Events related to the unavailability of | |
| | the access control policy related to the | |
| | service APIs | |

### *** Next Change ***

### 9.1 AEF_Security_API

### 9.1.1 API URI

The request URI used in each HTTP request from the API invoker towards the API exposing function shall have the following structure:
The {apiRoot} shall be as defined in the service API specification using CAPIF.
The {apiName} shall be “aef-security”.
The {apiVersion} shall be “v1”.
The {custOpName} shall be set as described in subclause 9.1.2a.

### 9.1.2 Resources

There is no resource defined for this API.
9.1.2.2.2

### *** Next Change ***

9.1.2a Custom Operations without Associated Resources

### 9.1.2a.1 Overview

Custom operations used for this API are summarized in table 9.1.2a.1-1. “apiRoot” is set as described in subclause 7.5.

TABLE 9.1.2a.1-1
Custom operations without associated resources

| | Mapped | |
|---|---|---|
| Custom operation URI | HTTP method | Description |
| {apiRoot}/aef-security/v1/ | POST | Check authenticaton |
| check-authentication | | request. |
| {apiRoot}/aef-security/v1/ | POST | Revoke authorization |
| revoke-authorization | | for service APIs. |

### 9.1.2a.2 Operation: Check-Authentication

### 9.1.2a.2.1 Description

This custom operation allows the API invoker to request API exposing function to confirm that necessary authentication data is available which is used to authenticate the API invoker at API invocation later.

### 9.1.2a.2.2 Operation Definition

This operation shall support the request and response data structures, and response codes specified in tables 9.1.2a.2.2-1 and 9.1.2a.2.2-2.

TABLE 9.1.2a.2.2-1
Data structures supported by the POST
Request Body on this operation

| Data type | P | Cardinality | Description |
|---|---|---|---|
| CheckAuthenticationReq | M | 1 | Authentication check request data |

TABLE 9.1.2a.2.2-2
Data structures supported by the POST
Request Body on this operation

| | | | Response | |
|---|---|---|---|---|
| Data type | P | Cardinality | codes | Description |
| CheckAuthenticationRsp | M | 1 | 200 OK | The request |
| | | | | was |
| | | | | successful. |

NOTE:
In addition, the HTTP status codes which are specified as mandatory in table 5.2.7.1-1 of 3GPP TS 29.500 [xx] for the POST method shall also apply.

### 9.1.2a.3 Operation: Revoke-Authorization

### 9.1.2a.3.1 Description

This custom operation allows the CAPIF core function to request the API exposing function to revoke the authorization of service APIs for an API invoker.

### 9.1.2a.3.2 Operation Definition

This operation shall support the request and response data structures, and response codes specified in tables 9.1.2a.2.3-1 and 9.1.2a.2.3-2.

TABLE 9.1.2a.2.3-1
Data structures supported by the POST
Request Body on this operation

| Data type | P | Cardinality | Description |
|---|---|---|---|
| RevokeAuthorizationReq | M | 1 | Authorization revocation |
| | | | request data |

TABLE 9.1.2a.2.3-2
Data structures supported by the POST Response Body on this operation

| Data type | P | Cardinality | Response codes | Description |
|---|---|---|---|---|
| RevokeAuthorizationRsp | M | 1 | 200 OK | The request was successful. |

NOTE:
In addition, the HTTP status codes which are specified as mandatory in table 5.2.7.1-1 of 3GPP TS 29.500 [xx] for the POST method shall also apply.

### *** Next Change ***

### 9.1.4.1 General

This subclause specifies the application data model supported by the API. Data types listed in subclause 7.2 apply to this API.
Table 9.1.4.1-1 specifies the data types defined specifically for the AEF_Authentication_API service.

TABLE 9.1.4.1-1
AEF_Security_API specific Data Types

| | Section | | |
|---|---|---|---|
| Data type | defined | Description | Applicability |
| n/aCheckAuthenticationReq | Subclause | Authentication | |
| | 9.1.4.2.b | check request | |
| | | data | |
| CheckAuthenticationRsp | Subclause | Authentication | |
| | 9.1.4.2.c | check response | |
| | | data | |
| RevokeAuthorizationReq | Subclause | Authorization | |
| | 9.1.4.2.d | revocation | |
| | | request data | |
| RevokeAuthorizationRsp | Subclause | Authorization | |
| | 9.1.4.2.e | revocation | |
| | | response data | |

Table 9.1.4.1-2 specifies data types re-used by the CAPIF_API_Invoker_Management_API service.

TABLE 9.1.4.1-2
Re-used Data Types

| Data type | Reference | Comments | Applicability |
|---|---|---|---|
| nSecurityNotification | Subclause | Information about | |
| | 8.5.4.2.5 | the revoked APIs | |
| SupportedFeatures | 3GPP TS | Used to negotiate | |
| | 29.571 [19] | the applicability of | |
| | | optional features | |
| | | defined in | |
| | | table 9.1.6-1. | |

### *** Next Change ***

### 9.1.4.2 Structured Data Types

### 9.1.4.2.a Introduction

This subclause defines the structures to be used in resource representations. 9.1.4.2.b Type: CheckAuthenticationReq

TABLE 9.1.4.2.b-1
Definition of type CheckAuthenticationReq

| Attribute | Data | | | | |
|---|---|---|---|---|---|
| name | type | P | Cardinality | Description | Applicability |
| apiInvoker | string | M | 1 | API invoker ID assigned by | |
| Id | | | | the CAPIF core function to | |
| | | | | the API invoker while | |
| | | | | on-boarding the API invoker. | |
| supportedFeaures | SupportedFeatures | M | 1 | Used to negotiate the | |
| | | | | supported optional features | |
| | | | | of the API as described in | |
| | | | | subclause 7.8. | |

### 9.1.4.2.c Type: CheckAuthenticationRsp

TABLE 9.1.4.2.c-1
Definition of type CheckAuthenticationRsp

| Attribute | Data | | | | |
|---|---|---|---|---|---|
| name | type | P | Cardinality | Description | Applicability |
| supportedFeaures | SupportedFeatures | M | 1 | Used to negotiate the | |
| | | | | supported optional features | |
| | | | | of the API as described in | |
| | | | | subclause 7.8. | |

### 9.1.4.2.d Type: RevokeAuthorizationReq

TABLE 9.1.4.2.d-1
Definition of type RevokeAuthorizationReq

| Attribute | Data | | | | |
|---|---|---|---|---|---|
| name | type | P | Cardinality | Description | Applicability |
| revokeInfo | SecurityNotification | M | 1 | It contains detailed | |
| | | | | revocation information | |
| supportedFeaures | SupportedFeatures | M | 1 | Used to negotiate the | |
| | | | | supported optional features | |
| | | | | of the API as described in | |
| | | | | subclause 7.8. | |

### 9.1.4.2.e Type: RevokeAuthorizationRsp

TABLE 9.1.4.2.e-1
Definition of type RevokeAuthorizationRsp

| Attribute | Data | | | | |
|---|---|---|---|---|---|
| name | type | P | Cardinality | Description | Applicability |
| supportedFeaures | SupportedFeatures | M | 1 | Used to negotiate the | |
| | | | | supported optional features | |
| | | | | of the API as described in | |
| | | | | subclause 7.8. | |

### *** Next Change ***

### 10.2 CAPIF-2/2e Security and Securely Invoking Service APIs

For secure communication between API invoker and API exposing function and ensuring secure invocations of service APIs, the API invoker:
shall negotiate the security method with the CAPIF core function using the Obtain_Security_Method service operation of the CAPIF_Security_API;
shall initiate the authentication with the API exposing function using the Initiate Authentication service operation of the AEF_Security_API; and
shall establish a secure connection with the API exposing function as defined in 3GPP TS 33.122 [16], using the method negotiated with the CAPIF core function.
   The embodiments of the disclosure further include:

### 1. Revoke Authorization for Some APIs

The standard DELETE method cannot be used by the AEF since it will remove the authorization for all APIs. If for instance, certain APIs are invoked very frequently by the API invoker and the number of invocations exceeds certain limit by the access control policy in the AEF, the AEF may decide to revoke the authorization for those APIs, but still decide to keep the rest APIs accessible.
The custom operation POST is proposed to be able to include message body indicating details for API authorization revocation.

### 2. Security Method Negotiation (as Shown in FIG. 11)

After initial negotiation of security methods supported by the API invoker and the CAPIF core function. The API invoker may be notified about the API capability change from the CAPIF core function for certain AEFs (due to security method update from the AEF), it should start a re-negotiation of the security methods.
The update of obtaining security method cannot be achieved by standard Restful PUT method, since the resource representation (esp. selected security method) may be changed between two consecutive PUTs with the same request content. E.g. after the 1^{st} PUT, the AEF updates the CAPIF core function with an updated security methods. Then the 2^{nd} PUT response may include a different resource representation. This behavior is not aligned with Restful PUT method where the same resource representation should be returned for two consecutive PUT with exactly the same request content.
Therefore, a custom operation by POST is proposed for the update of obtaining security method between the CAPIF.

### Proposed Changes:

### *** Next Change ***

### 5.6.1.1 Overview

The CAPIF security APIs, as defined in 3GPP TS 23.222 [2], allow:
API invokers via CAPIF-1/1e reference points to (re-)negotiate the service security method and obtain authorization for invoking service APIs; and
API exposing function via CAPIF-3 reference point to obtain authentication information of the API invoker for authentication of the API invoker and revoke the authorization for service APIs.

### *** Next Change ***

### 5.6.2.4.2 Obtain API Invoker's Security Information Using Obtain_API_Invoker_Info Service Operation

To obtain authentication or authorization information from the CAPIF core function to authenticate or authorize an API invoker, the API exposing function shall send an HTTP GET message to the CAPIF core function with the API invoker ID and an indication to request authentication and/or authorization information.
Upon receiving the above described HTTP GET message, the CAPIF core function shall:
1. determine the security information of API invoker for all the service API interfaces of the API exposing function; and
2. return the security information in the response message.

### *** Next Change ***

### 5.6.2.5.2 Invalidate Authorization Using Revoke_Authorization Service Operation

To invalidate authorization of an API invoker for all service APIs, the API exposing function shall send an HTTP DELETE message to the CAPIF core function using the API invoker ID.
Upon receiving the above described HTTP DELETE message, the CAPIF core function shall delete the resource representation pointed by the API invoker ID and shall notify the API invoker of the authorization invalidation using the Notification Destination URI received in the Obtain_Security_Method message.
Or alternatively, to invalidate authorization of an API invoker for some service APIs, the API exposing function shall send an HTTP POST message to the CAPIF core function with the API invoker ID and a list of API identifiers.
Upon receiving the HTTP POST message, the CAPIF core function shall revoke the authorization for the indicated API invoker and service APIs and shall notify the API invoker of the authorization invalidation using the Notification Destination URI received in the Obtain_Security_Method message.
In both alternatives, the CAPIF core function shall acknowledge the HTTP request from the API exposing function.

### *** Next Change ***

### 8.5.2.1 Overview

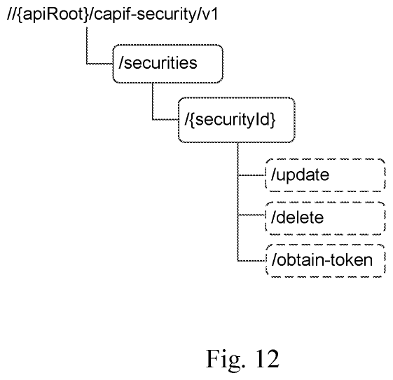

FIG. 12 shows a resource URI structure of the CAPIF_Security_API.
Table 8.5.2.1-1 provides an overview of the resources and applicable HTTP methods.

TABLE 8.5.2.1-1
Resources and methods overview

| | | HTTP | |
|---|---|---|---|
| | | method or | |
| Resource | | custom | |
| name | Resource URI | operation | Description |
| Trusted | {apiRoot} | POST | All security |
| API | /capif-security/vl | | instances |
| Security | /securities | GET | Retrieve |
| collection | | | authentication |
| | | | and/or |
| | | | authorization |
| | | | information of |
| | | | an API invoker |
| Individual | {apiRoot} | GET | Retrieve |
| security | /capif-security/vl | | authentication |
| instance | /securities/{securityId} | | information of |
| | | | an API invoker |
| | | DELETE | Revoke the |
| | | | authorization of |
| | | | the API invoker |
| | {apiRoot} | Update | Update the |
| | /capif-security/vl/securities/ | (POST) | security |
| | {securityId} | | instance (e.g. |
| | /update | | re-negotiate the |
| | | | security |
| | | | methods). |
| | {apiRoot} | Delete | Revoke the |
| | /capif-security/vl/securities/ | (POST) | authorization of |
| | {securityId} | | the API invoker |
| | /delete | | for APIs |

### *** Next Change ***

### 8.5.2.2 Resource: Security Collection

### *** Next Change ***

### 8.5.2.2.1 Description

The Security collection resource represents all the API invokers that are trusted by the CAPIF core function and have received authentication information from the CAPIF core function.

### *** Next Change ***

### 8.5.2.2.2 Resource Definition

Resource URI: {apiRoot}/capif-security/v1/securities
This resource shall support the resource URI variables defined in table 8.5.2.2.2-1.

TABLE 8.5.2.2.2-1
Resource URI variables for this resource

| Name | Definition |
|---|---|
| apiRoot | See subclause 7.5 |

### *** Next Change ***

### 8.5.2.2.3.1 POST

This method shall support the URI query parameters specified in table 8.5.2.2.3.1-1.

TABLE 8.5.2.2.3.1-1
URI query parameters supported by the POST
method on this resource

| Name | Data type | P | Cardinality | Description |
|---|---|---|---|---|
| n/a | | | | |

This method shall support the request data structures specified in table 8.5.2.2.3.1-2 and the response data structures and response codes specified in table 8.5.2.2.3.1-3.

TABLE 8.5.2.2.3.1-2
Data structures supported by the POST Request Body on
this resource

| Data type | P | Cardinality | Description |
|---|---|---|---|
| ServiceSecurity | M | 1 | Security method request from the API |
| | | | invoker to the CAPIF core function. |
| | | | The request indicates a list of service |
| | | | APIs and a preferred method of security |
| | | | for the service APIs. |
| | | | The request also includes a notification |
| | | | destination URI for security related |
| | | | notifications. |

TABLE 8.5.2.2.3.1-3
Data structures supported by the POST Response Body on
this resource

| | | | Response | |
|---|---|---|---|---|
| Data type | P | Cardinality | codes | Description |
| ServiceSecurity | M | 1 | 201 | Security method from the |
| | | | Created | CAPIF core function to the |
| | | | | API invoker is based on |
| | | | | the received request. The |
| | | | | response indicates the |
| | | | | security method to be |
| | | | | used for the service APIs |
| | | | | The URI of the created |
| | | | | resource shall be returned |
| | | | | in the “Location” HTTP |
| | | | | header. |

NOTE:
In addition, the HTTP status codes which are specified as mandatory in table 5.2.7.1-1 of 3GPP TS 29.500 [xx] for the POST method shall also apply.

### *** Next Change ***

### 8.5.2.2.3.x GET

This method shall support the URI query parameters specified in table 8.5.2.2.3.x-1.

TABLE 8.5.2.2.3.x-1
URI query parameters supported by the GET method on
this resource

| Name | Data type | P | Cardinality | Description |
|---|---|---|---|---|
| api-invoker-id | string | M | 1 | API invoker identifier. |
| authentication | boolean | O | 0 . . . 1 | When set to ‘true’, it |
| | | | | indicates the CAPIF core |
| | | | | function to send the |
| | | | | authentication infor- |
| | | | | mation of the API |
| | | | | invoker. Set to false |
| | | | | or omitted otherwise. |
| authorization | boolean | O | 0 . . . 1 | When set to ‘true’, it |
| | | | | indicates the CAPIF core |
| | | | | function to send the |
| | | | | authorization infor- |
| | | | | mation of the API |
| | | | | invoker. Set to false or |
| | | | | omitted otherwise. |

This method shall support the request data structures specified in table 8.5.2.2.3.x-2 and the response data structures and response codes specified in table 8.5.2.2.3.x-3.

TABLE 8.5.2.2.3.x-2
Data structures supported by the GET Request Body on this
resource

| Data type | P | Cardinality | Description |
|---|---|---|---|
| n/a | | | |

TABLE 8.5.2.2.3.x-3
Data structures supported by the GET Response Body on
this resource

| | | | Response | |
|---|---|---|---|---|
| Data type | P | Cardinality | codes | Description |
| ServiceSecurity | M | 1 | 200 OK | The security related infor- |
| | | | | mation of the API Invoker |
| | | | | based on the request from |
| | | | | the API exposing function. |

NOTE:
In addition, the HTTP status codes which are specified as mandatory in table 5.2.7.1-1 of 3GPP TS 29.500 [xx] for the GET method shall also apply.

### *** Next Change ***

### 8.5.2.3 Resource: Individual Security Instance

### *** Next Change ***

### 8.5.2.3.1 Description

The Individual security instance resource represents an individual API invokers that is trusted by the CAPIF core function and have received security related information from the CAPIF core function.

### *** Next Change ***

### 8.5.2.3.2 Resource Definition

Resource URI: {apiRoot}/capif-security/v1/securities/{securityId}
This resource shall support the resource URI variables defined in table 8.5.2.3.2-1.

TABLE 8.5.2.3.2-1
Resource URI variables for this resource

| Name | Definition |
|---|---|
| apiRoot | See subclause 7.5 |
| securityId | String identifying an individual security instance |

### *** Next Change ***

### 8.5.2.3.3.1 Void

### *** Next Change ***

### 8.5.2.3.3.2 Delete

This method shall support the URI query parameters specified in table 8.5.2.3.3.2-1.

TABLE 8.5.2.3.3.2-1
URI query parameters supported by the DELETE method
on this resource

| Name | Data type | P | Cardinality | Description |
|---|---|---|---|---|
| n/a | | | | |

This method shall support the request data structures specified in table 8.5.2.3.3.2-2 and the response data structures and response codes specified in table 8.5.2.3.3.2-3.

TABLE 8.5.2.3.3.2-2
Data structures supported by the DELETE Request Body
on this resource

| Data type | P | Cardinality | Description |
|---|---|---|---|
| n/a | | | |

TABLE 8.5.2.3.3.2-3
Data structures supported by the DELETE Response Body
on this resource

| | | | Response | |
|---|---|---|---|---|
| Data type | P | Cardinality | codes | Description |
| n/a | | | 204 No | Authorization of the API invoker |
| | | | Content | revoked, and a notification is |
| | | | | sent to the API invoker as |
| | | | | specified in subclause 8.5.3.2 |

NOTE:
In addition, the HTTP status codes which are specified as mandatory in table 5.2.7.1-1 of 3GPP TS 29.500 [xx] for the DELETE method shall also apply.

### *** Next Change ***

### 8.5.2.3.4 Resource Custom Operations

### 8.5.2.3.4.a Overview

TABLE 8.5.2.3.a-1
Custom operations

| | Mapped | |
|---|---|---|
| | HTTP | |
| Custom operation URI | method | Description |
| {apiRoot} | POST | Update the security |
| /capif-security/v1/securities/ | | instance (e.g. |
| {securityId}/update | | re-negotiate the security |
| | | methods). |
| {apiRoot} | POST | Revoke the |
| /capif-security/v1/securities/ | | authorization of the API |
| {securityId}/delete | | invoker for APIs |

### 8.5.2.3.4.b Operation: Update

### 8.5.2.3.4.b.1 Description

### 8.5.2.3.4.b.2 Operation Definition

This custom operation updates an existing Individual security instance resource in the CAPIF core function.
This operation shall support the request data structures specified in table 8.5.2.3.4.b.2-1 and the response data structure and response codes specified in table 8.5.2.3.4.b.2-2.

TABLE 8.5.2.3.4.b.2-1
Data structures supported by the POST Reques Body on
this resource

| Data type | P | Cardinality | Description |
|---|---|---|---|
| ServiceSecurity | M | 1 | Security method request from the API |
| | | | invoker to the CAPIF core function. |
| | | | The request indicates a list of service |
| | | | APIs and a preferred method of security |
| | | | for the service APIs. |
| | | | The request also includes a notification |
| | | | destination URI for security related |
| | | | notifications. |

TABLE 8.5.2.3.4.b.2-2
Data structures supported by the POST Response Body on
this resource

| | | | Response | |
|---|---|---|---|---|
| Data type | P | Cardinality | codes | Description |
| ServiceSecurity | M | 1 | 200 OK | Security method from the |
| | | | | CAPIF core function to the |
| | | | | API invoker is based on the |
| | | | | received request. The re- |
| | | | | sponse indicates the security |
| | | | | method to be used for |
| | | | | the service APIs |

NOTE:
In addition, the HTTP status codes which are specified as mandatory in table 5.2.7.1-1 of 3GPP TS 29.500 [5] for the POST method shall also apply.

### 8.5.2.3.4.c Operation: Delete

### 8.5.2.3.4.c.1 Description

### 8.5.2.3.4.c.2 Operation Definition

This custom operation revokes authorization for service APIs of an existing Individual security instance resource in the CAPIF core function.
This operation shall support the request data structures specified in table 8.5.2.3.4.c.2-1 and the response data structure and response codes specified in table 8.5.2.3.4.c.2-2.

TABLE 8.5.2.3.4.c.2-1
Data structures supported by the POST Request Body on
this resource

| Data type | P | Cardinality | Description |
|---|---|---|---|
| SecurityNotification | M | 1 | It includes a list of APIs to be |
| | | | revoked for an API invoker. |

TABLE 8.5.2.3.4.c.2-2
Data structures supported by the POST Response Body on
this resource

| | | | Response | |
|---|---|---|---|---|
| Data type | P | Cardinality | codes | Description |
| n/a | | | 204 No | Successful case. |
| | | | Content | The CAPIF core function |
| | | | | revoked the authorization |
| | | | | for the requested APIs to |
| | | | | the API invoker. |

NOTE 1:
In addition, the HTTP status codes which are specified as mandatory in table 5.2.7.1-1 of 3GPP TS 29.500 [5] for the POST method shall also apply.

### *** Next Change ***

### 8.5.4.2.5 Type: SecurityNotification

TABLE 8.5.4.2.5-1
Definition of type SecurityNotification

| Attribute | Data | | | | Appli- |
|---|---|---|---|---|---|
| name | type | P | Cardinality | Description | cability |
| apiInvoker | string | M | 1 | String identifying | |
| Id | | | | the API invoker | |
| | | | | assigned by the | |
| | | | | CAPIF core function | |
| aefId | string | M | 1 | String identifying | |
| | | | | the AEF. | |
| apiIds | array(st | M | 1 . . . N | Identifier of the | |
| | ring) | | | service API | |
| cause | Cause | M | 1 | The cause for | |
| | | | | revoking the API | |
| | | | | invoker authorization | |
| | | | | to the service API | |

1. A method for revoking authorization for an Application Program Interface (API) invoker in a first apparatus, comprising:
sending, to a second apparatus, a request for revoking authorization of an API for the API invoker with an API invoker ID, an API Exposing Function (AEF) identifier and at least one API identifier; and
receiving a response to the request from the second apparatus;
wherein the API identified by the at least one API identifier is part of all APIs authorized for the API invoker.

2. The method according to claim 1, wherein the first apparatus is an AEF and the second apparatus is an authorization server.

3. The method according to claim 1, wherein the first apparatus is an authorization server and the second apparatus is an AEF.

4. The method according to claim 1, wherein the request is sent, via an HTTP POST message containing the API invoker ID, the AEF identifier and the at least one API identifier, to an URI on the second apparatus.

5. The method according to claim 4, wherein the HTTP POST message further contains a cause for revoking the authorization of the API identified by the at least one API identifier for the API invoker.

6. The method according to claim 2, wherein the AEF comprises:
a Service Capability Exposure Function (SCEF); a Network Exposure Function (NEF); or a Broadcast Multicast Service Center (BMSC); and the authorization server comprises a Common API Framework (CAPIF) Core function.

7. The method according to claim 2, further comprising:
invalidating the authorization of the API indicated by the at least one API identifier with the AEF for the API invoker.

8. The method according to claim 3, further comprising:
notifying the API invoker of revocation of the authorization of API identified by the at least one API identifier with the AEF.

9. The method according to claim 1, wherein the response to the request from the second apparatus comprises an acknowledge message for the request.

10. A method for revoking authorization for an Application Program Interface (API) invoker in a second apparatus, comprising:
receiving, from a first apparatus, a request for revoking authorization of an API for the API invoker with an API invoker ID, an API Exposing Function (AEF) identifier and at least one API identifier; and
sending a response to the request to the first apparatus;
wherein the API identified by the at least one API identifier is part of all APIs authorized for the API invoker.

11. The method according to claim 10, wherein the first apparatus is an AEF and the second apparatus is an authorization server.

12. The method according to claim 10, wherein the first apparatus is an authorization server and the second apparatus is an AEF.

13. The method according to claim 10, wherein the request is received, via an HTTP POST message containing the API invoker ID, the AEF identifier and the at least one API identifier.

14. The method according to claim 13, wherein the HTTP POST message further contains a cause for revoking the authorization of the API identified by the at least one API identifier for the API invoker.

15. The method according to claim 11 or 12, wherein the AEF comprises:
a Service Capability Exposure Function (SCEF); a Network Exposure Function (NEF); or a Broadcast Multicast Service Center (BMSC); and the authorization server comprises a Common API Framework (CAPIF) Core function.

16. The method according to claim 11, further comprising:
invalidating the authorization of the API indicated by the at least one API identifier with the AEF for the API invoker.

17. The method according to claim 11, further comprising:
notifying the API invoker of revocation of the authorization of API identified by the at least one API identifier with the AEF.

18. The method according to claim 10, wherein the response to the request to the first apparatus comprises an acknowledge message for the request.

19. (canceled)

20. A first apparatus for revoking authorization of an Application Program Interface (API) invoker, comprising:
one or more processors; and
one or more memories comprising computer program which, when executed by the one or more processors, cause the first apparatus to:
send, to a second apparatus, a request for revoking authorization of an API for the API invoker with an API invoker ID, an API Exposing Function (AEF) identifier and at least one API identifier; and
receive a response to the request from the second apparatus;
wherein the API identified by the at least one API identifier is part of all APIs authorized for the API invoker.

21. (canceled)

22. A second apparatus for revoking authorization of an Application Program Interface (API) invoker, comprising:
one or more processors; and
one or more memories comprising computer program which, when executed by the one or more processors, cause the second apparatus to:
receive, from a first apparatus, a request for revoking authorization of an API for the API invoker with an API invoker ID, an API Exposing Function (AEF) identifier and at least one API identifier; and
send a response to the request to the first apparatus;
wherein the API identified by the at least one API identifier is part of all APIs authorized for the API invoker.

23. (canceled)
